(19) United States
(12) Patent Application Publication
(10) Pub. No.: US 2015/0138931 A1
(43) Pub. Date: May 21, 2015

(54) TIMEPIECE BALANCE SPRING STUD-HOLDER WITH SCREWS

(71) Applicant: ETA SA Manufacture Horlogere Suisse, Grenchen (CH)

(72) Inventors: Raphael COURVOISIER, Corcelles (CH); Christian Ruefenacht, Bienne (CH)

(73) Assignee: ETA SA Manufacture Horlogere Suisse, Grenchen (CH)

(21) Appl. No.: 14/519,782

(22) Filed: Oct. 21, 2014

(30) Foreign Application Priority Data
Nov. 20, 2013 (EP) 13193627.0

(51) Int. Cl. G04B 17/32; G04B 15/14

(52) U.S. Cl. CPC G04B 17/32; G04B 15/14
USPC 368/127

(57) ABSTRACT

Assembly for holding a balance spring including a stud including a surface for orienting a balance spring, and a stud-holder, which includes:
a first housing for receiving the balance spring stud;
means for securing the stud including a screw orthogonal to the stud;
means of securing the stud-holder to an escapement mechanism.

The screw partially passes through the stud to hold the stud in an indexed position.

The stud includes a second housing for the contact-free passage of the screw.

The stud-holder includes on either side of the first housing:
an internal thread cooperating with the screw;
a third bore for the passage of a head of the screw (5) cooperating in abutment with the orientation surface (7).

This application claims priority from European Patent Application No. 13193627.0 filed 20 Nov. 2013, the entire disclosure of which is incorporated herein by reference.

### FIELD OF THE INVENTION

The invention concerns an assembly for holding or supporting a timepiece balance spring including a balance spring stud and a stud-holder, wherein said stud-holder includes:
a first housing for receiving said balance spring stud;
means of securing said balance spring stud including at least one screw whose axis is orthogonal to that of said stud;
and means of securing said stud-holder to an escapement mechanism, said balance spring stud including at least one orientation surface defining a direction of holding or supporting a said balance spring, wherein said at least one screw at least partially passes through said balance spring stud to hold the stud in an indexed locking position.

The invention also concerns a timepiece escapement mechanism including at least one such assembly.

The invention also concerns a timepiece movement including at least one such escape mechanism.

The invention also concerns a timepiece comprising at least one such movement.

The invention concerns the field of timepiece escapement mechanisms including a balance spring.

### BACKGROUND OF THE INVENTION

In numerous mass-produced calibres, the balance spring stud, forming the external point of attachment of the balance spring, is clipped to a stud-holder, which is a flat, stamped part.

In high end productions, the balance spring stud is screwed into a stud-holder which is a machined component. The retaining screw then works between the foot and threads of the screw. The head is never locked, which causes frequent breakage, as a result of the torsion stresses experienced when the foot is locked onto the balance spring stud and when the operator continues to turn the screw.

DE Utility Model No 202010024253 in the name of DAMASKO describes a balance spring stud with radial adjustment relative to the balance cock. The axially threaded stud cooperates with a cylindrical screw, whose head moves in a milled oblong groove.

EP Patent Application No 2290477A1 in the name of GLASHÜTTE UHRENBETRIEB describes a stud-holder which includes an internal thread for securing the stud retaining screw, which cooperates with a recess in said stud, over one part of the thickness of the stud.

### SUMMARY OF THE INVENTION

The invention proposes to create a modified balance spring stud, so as to correct the use of the screw, so that the screw can operate normally, by elastic deformation between its head and threads. Thus, the issue is to reduce the risk of breakage while maintaining the high-end structure of a stud holder with screws. To this end, the invention concerns an assembly for holding or supporting a timepiece balance spring including a balance spring stud and a stud-holder, wherein the stud-holder includes:
a first housing for receiving said balance spring stud;
means of securing said balance spring stud including at least one screw whose axis is orthogonal to that of said stud;
and means of securing said stud-holder to an escapement mechanism, said balance spring stud including at least one orientation surface defining a direction of holding or supporting a said balance spring, wherein said at least one screw at least partially passes through said balance spring stud to hold the stud in an indexed locking position, characterized in that said stud includes at least a second housing for the contact-free passage of said at least one screw, and said stud-holder includes:
on a first side of said first housing for said balance spring stud, an internal thread cooperating with said at least one screw;
on a second side of said first housing for said balance spring stud, a third bore for the passage of a screw head comprised in said at least one screw, said screw head cooperating with said orientation surface of said balance spring stud formed by a flat portion.

The invention also concerns a timepiece escapement mechanism including at least one such assembly.

The invention also concerns a timepiece movement including at least one such escape mechanism.

The invention also concerns a timepiece including at least one movement of this type, characterized in that the timepiece is a watch.

### BRIEF DESCRIPTION OF THE DRAWINGS

Other features and advantages of the invention will appear upon reading the following detailed description, with reference to the annexed drawings, in which:

FIG. 1 shows a schematic, plan view of an assembly for holding a balance spring according to the prior art, including a stud-holder, a stud housed in a bore of the stud-holder, and a screw engaged in an internal thread of the stud-holder and bearing on the stud;

FIG. 2 is a cross-section, in a plane through the axis of the screw and the axis of the stud, of the assembly of FIG. 1.

FIG. 3 shows a schematic, perspective, exploded view of the assembly of FIG. 1.

FIG. 4 shows, in a similar manner to FIG. 1, a first embodiment of the invention, wherein the screw passes through a bore of the balance spring stud and cooperates, on the opposite side to the screw head, with an internal thread of the stud-holder.

FIG. 5 shows, in a similar manner to FIG. 2, the assembly of FIG. 4.

FIG. 6 shows, in a similar manner to FIG. 3, the assembly of FIG. 4.

FIG. 7 is a block diagram showing a timepiece comprising a movement which includes an escapement mechanism including a balance spring held by an assembly according to the invention.

### DETAILED DESCRIPTION OF PREFERRED EMBODIMENTS

The invention concerns an assembly 20 for holding or supporting a timepiece balance spring 21 including a balance spring stud 1 and a stud-holder 2.

This stud-holder 2 includes:
a first housing 3 for receiving balance spring stud 1;
means 4 for securing stud 1 including at least one screw 5;
and means 6 of securing stud-holder 2 to an escapement mechanism 30,

Balance spring stud 1 includes at least one orientation surface 7 defining a direction of holding or supporting a balance spring 21 of this type.

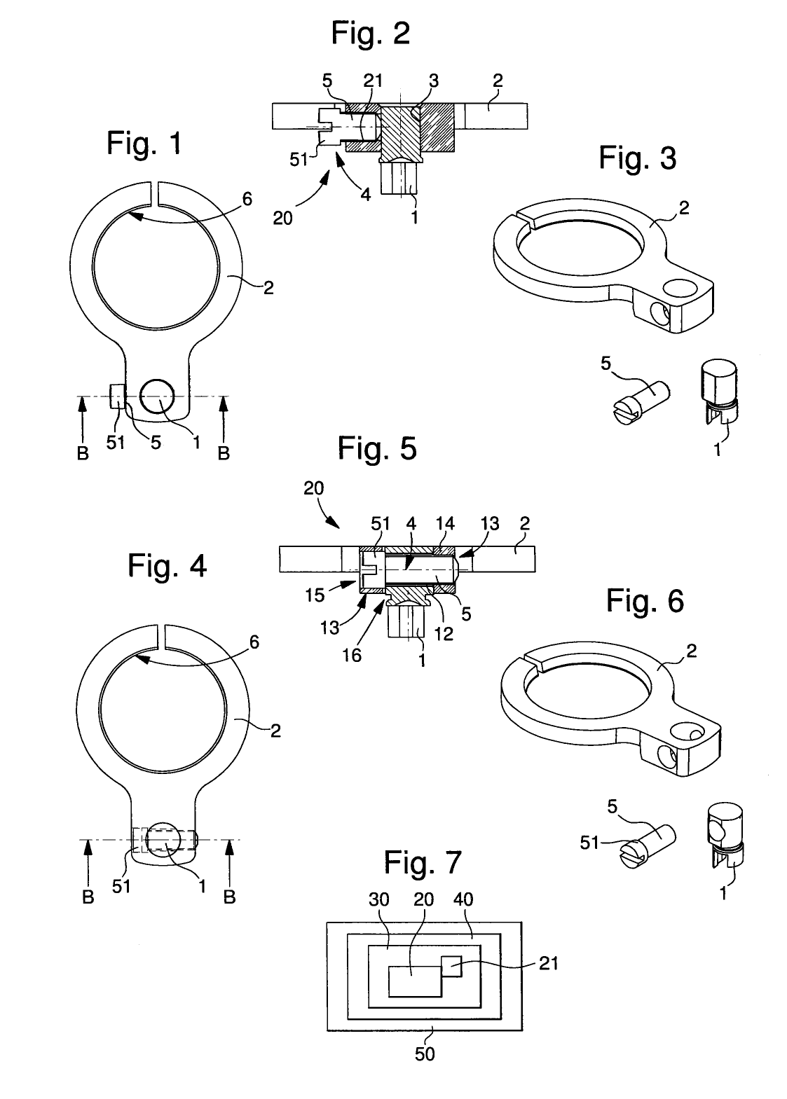

FIG. 1 illustrates the prior art, with a balance spring stud 1 housed in a bore 3 of stud-holder 2 and a screw 5, whose axis is orthogonal to that of stud 1 and which is engaged in an internal thread 21 of stud-holder 2 and bears on a lateral face of stud 1.

This at least one screw 5 at least partially passes through balance spring stud 1 to hold the stud in an indexed locking position.

Stud-holder 2 may include a recess to allow for adjustment of the flatness of the balance spring by unscrewing the screw. Indeed, watchmakers take care always to position the balance spring so that it is as flat as possible. If the point of attachment on the stud is, for example, lower than the point of attachment on the balance staff, the balance spring will tend to adopt an umbrella shape. To correct this phenomenon, the watchmaker unscrews the stud screw and raises the stud until the two points of attachment are at the same height, and the balance spring is thus made flat again. However, this adjustment is only possible where the stud can be moved inside the stud-holder.

In the embodiment of the invention, the through hole passing through the stud prevents movement. An adjustment is not possible in a version with a cylindrical hole; in a variant an oblong allows for this adjustment in height.

As seen in FIGS. 4 to 6, balance spring stud 1 includes at least a second housing 12 for the contact-free passage of said at least one screw 5 and said stud-holder 1 includes:
on a first side 13 of said first housing 3 for said balance spring stud 1, an internal thread 14 cooperating with said at least one screw 5;
on a second side 15 of said first housing 3 for said balance spring stud 1, a third bore 13 for the passage of a screw head 51 comprised in said at least one screw 5, said screw head 51 cooperating with said orientation surface 7 of said stud 1 formed by a flat portion 16.

Balance spring stud 1 is pushed against stud-holder 2 by screw 5 and the orientation is given by screw head 51.

In a first variant, to allow for a height adjustment of balance spring stud 1, this at least one second housing 12 is oblong in a direction perpendicular to that of said at least one screw 5, for the height adjustment of said balance spring stud 1.

In a second variant, to allow for a height adjustment of stud 1 as explained above, this at least one second housing 12 is of greater size than the outer diameter of the external thread of said at least one screw 5, particularly in the form of an oblong, with an adjustment play J for the height adjustment of balance spring stud 1. The diameter of screw head 51 is sized to remain in abutment on the periphery of second housing 12 in every adjustment position of balance spring stud 1.

Preferably, there is only one screw 5, and only one internal thread 12 of stud 1.

The invention also concerns a timepiece escapement mechanism 30 including at least one such assembly 20.

The invention also concerns a timepiece movement 40 including at least one escapement mechanism 30 of this type.

The invention also concerns a timepiece 50 including at least one such movement 40. Specifically, this timepiece 50 is a watch.

The invention provides various advantages:
the screw does not work in torsion, but in traction, and the risk of breaking the screw is reduced;
a stable adjustment is ensured and allows for integration into a high-end movement;
a height adjustment is possible;
the stud-holder assembly according to the invention is interchangeable with a prior art stud-holder, which makes it possible to improve existing movements.

What is claimed is:

1. An assembly for holding or supporting a timepiece balance spring including a balance spring stud and a stud-holder, wherein the stud-holder includes:
a first housing for receiving said balance spring stud;
means of securing said balance spring stud including at least one screw whose axis is orthogonal to that of said stud;
and means of securing said stud-holder to an escapement mechanism,
said balance spring stud including at least one orientation surface defining a direction of holding or supporting a said balance spring, wherein said at least one screw at least partially passes through said balance spring stud to hold the stud in an indexed locking position,
characterized in that said stud includes at least a second housing for the contact-free passage of said at least one screw, and in that said stud-holder includes:
on a first side of said first housing for said stud, an internal thread cooperating with said at least one screw;
on a second side of said first housing for said stud, a third bore for the passage of a screw head comprised in said at least one screw, said screw head cooperating with said orientation surface of said stud formed by a flat portion.

2. The assembly according to claim 1, characterized in that said at least one second housing is oblong in a direction perpendicular to that of said at least one screw, for the height adjustment of said stud.

3. The assembly according to claim 2, characterized in that said at least one second housing is of larger size than the outer diameter of the external thread of said at least one screw, with an adjustment play for the height adjustment of said stud, the diameter of said screw head being sized to remain in abutment on the periphery of said second housing in every adjustment position of said stud.

4. The timepiece escapement mechanism including at least one assembly according to claim 1.

5. The timepiece movement including at least one escapement mechanism according to claim 4.

6. The timepiece including at least one movement according to claim 5, characterized in that the timepiece is a watch.
